(19) United States
(12) Patent Application Publication
(10) Pub. No.: US 2012/0213029 A1
(43) Pub. Date: Aug. 23, 2012

(54) APPARATUS AND METHOD FOR MIXING OF A MATERIAL TO BE MIXED

(75) Inventor: Roland Villiger, Zug (CH)

(73) Assignee: FRXSH AG, Kuessnacht am Rigi (CH)

(21) Appl. No.: 13/391,902

(22) PCT Filed: Aug. 26, 2009
(86) PCT No.: PCT/EP2009/061011

§ 371 Date: May 8, 2012

(51) Int. Cl. A47J 43/07; A23P 1/00; B01F 7/16

(52) U.S. Cl. 366/199

(57) ABSTRACT

The invention relates to a device (100) and to the use thereof for mixing material to be mixed. The device (100) comprises a container (10) having an opening, a lid (20) for closing the opening, and a mixer (40), which protrudes through the lid (20) into the interior of the container (10). Furthermore, a drive device (30) having a drive (M) for driving the mixer (40) is provided, wherein the drive device (30) has a connection area (31), which is designed in such a way that the container (10), together with the lid (20), can be connected to the connection area (31). In establishing the connection, the mixer (40) is coupled to the drive device (30) in a driven manner. The mixer (40) and the lid (20) form a fixed assembly. A first element (28, 29) is arranged in the lid (20) and a second element (S2) is arranged in the connection area (31), wherein said first element and second element interact with each other and activate a current supply to the drive (M) by means of the second element (S2), when the container (10), together with the lid (20), is placed.

### AREA OF THE INVENTION

The subject of the present invention is an apparatus and a method for mixing of a material to be mixed. In particular, the mixing of edibles is concerned, and in the area of edibles especially drinkable edibles.

### BACKGROUND OF THE INVENTION, STATE OF THE ART

There are many fields which concern the mixing of material to be mixed. In the following, the field of edibles is concerned primarily, although the invention can applied also in numerous different fields.

In the field of edibles, there are mixers, stirring staffs and other means for mixing edibles and ingredients with each other as needed in a private household and in professional kitchens. The preparing of a salad dressing is mentioned as an example. Here, the liquid and solid ingredients are often put into a mixing container, which is closeable with a lid. The constituents are mingled with other by shaking. In order to improve the stirring, there are containers, the lid of which has a fixedly standing arrangement of rods, which protrudes into the interior of the container and promotes the mixing. Also known are mixing containers, which comprise a stirring device, which is integrated in the lid and which is moveable by cranking a handle on the top side of the lid. Such containers typically comprise at least one spout so that the lid does not have to be taken off.

Also known are kitchen devices, which comprise a motor to automatize the mixing or stirring. An example of a typical kitchen mixer is shown in FIG. 1. The kitchen mixer comprises a drive device 4, which can be deposited for example on a work surface T. For mixing, a special container 1 is screwed on, which comprises a cap 5 that achieves several tasks. In the cap 5, a stirring device 3 is integrated, which protrudes into the interior of the special container 1. The cap 5 seals the special container 1 to the lower side and the cap 5 serves as a screw coupling with a connection section of the drive device 4. The cap 5 is typically welded or pasted on in order to avoid leakages. In addition to the corresponding lower opening, which is closed with the cap 5, the special container 1 has an upper opening, which is closeable spray-tightly by means of a lid 2.

The cap, which accommodates the stirring device 3, is often composed of several component parts, which are complex to assemble and disassemble.

It is a disadvantage of the previously known solutions that the effort for cleaning is often very high. In addition, some of the mentioned solutions require a series of special parts or equipment. However, aspects such as manageability, variability and flexibility play an important role especially in the field of edibles. In addition, it is important that such equipment should be dissassembleable as simple and complete as possible in order to satisfy the highest hygienic standards. It is a further problem of such equipments, that they are often used particularly in kitchens or public areas by multiple users. Thereby, ingredients may be mingled with each other, if for example the special container 1, together with the integrated stirring device 3, has not been sufficiently cleaned up.

It is thus an object to provide a simpler approach for mixing, mingling, stirring and even for chopping up or hacking up ingredients or other material to be mixed. The according means shall be applicable as universally as possible and a sufficient hygiene shall be ensured for each user.

According to the invention, a completely novel approach comes to application, which is based thereon that an apparatus comprising a container, for example a drinking bottle, is used, which comprises only one single opening. This opening is tightly closeable by means of a lid. A stirring device is envisaged, which is fixedly integrated in the lid, in such a way that after the closing of the opening by means of the lid the stirring device protrudes into the interior of the container. In addition, the apparatus comprises a drive device comprising a connection area, which is designed such that container, together with the lid, is attachable to or puttable on the connection area. Upon attaching the container to or putting it on, the stirring device is connected with the drive device as concerns the drive (preferably force-fittedly). If the drive device is now activated, it transfers the stirring device in rotation through the lid. The rotation of the stirring device effects the mixing or mingling of material to be mixed, which is present in the interior of the container.

The apparatus according to the invention enables a whole series of novel applications, which will gain importance in particular in the field of nutrition.

The apparatus according to the invention is applicable flexibly and may be cleaned without problems. Particularly advantageously is the fact, that the number of the component parts could be reduced to three basic elements. In total, the apparatus comprises namely only the lid with the fixedly integrated stirring device, the container, for example in the form of a drinking bottle, and the drive unit.

With this solution, the usual washing off of many single device pieces, part of which are accessible only with difficulty, is dispensed with. In addition, the decanting of mixtures for storage or further processing is dispensed with, because the mixture is provided in situ, i.e. directly in the container. The mixture can made, stored and transported absolutely hygienically. Depending on the design, also no third party has access to the mixture, which may be of importance especially in the field of high performance sports and of professional sports.

The apparatus according to the invention is suited in particular for a beverage mixer.

The apparatus according to the invention may be applied as a kitchen or gastronomy application for example in the preparation of soups, sauces, beverages, shakes, soft drinks, etc.

In the field of sports, the apparatus according to the invention may be applied for providing fitness drinks, fitness cocktails, fruit juices, power nutrition, etc.

The invention is suited for providing nutrition for babies and for providing liquefied nutrition in the field of hospitals, retirement homes and so on.

Due to the simple handling and because of the fact that there are only three basic elements, there result new and innovative possibilities for the catering.

The invention may be applied also in other fields, where the quick and unproblematic mixing of ingredients is concerned. The mixing of multi component materials, such as gluing or coloring materials, and the mixing of medicaments or dietary supplements are to be highlighted in particular.

### DRAWINGS

Further details and advantages of the invention are described in the following based on embodiment examples and with reference to the drawings, in which:

FIG. 1 shows a schematic side view of a known kitchen mixer (state of the art);

FIG. 2A-2H shows a sequence of schematized figures showing a possible application of an apparatus according to the invention;

FIG. 3A shows a schematic side view of an apparatus according to the invention in a first embodiment;

FIG. 3B shows a schematic side view of an apparatus according to the invention in a second embodiment;

FIG. 3C shows a schematic side view of an apparatus according to the invention in a third embodiment;

FIG. 4A shows a schematic side view of an apparatus according to the invention in a further embodiment with open switch;

FIG. 4B shows a schematic side view of the apparatus of FIG. 4A with closed switch;

FIG. 5A shows a schematic side view of an apparatus according to the invention in a further embodiment with open switch;

FIG. 5B shows a schematic side view of the apparatus of FIG. 5A with closed switch;

FIG. 6A shows a schematic top view of the lid of an apparatus according to the invention;

FIG. 6B shows a schematic side view of the lid of FIG. 6A; and

FIG. 7 shows a schematic cross sectional view of an apparatus according to the invention in a particularly preferred embodiment with a safety switch.

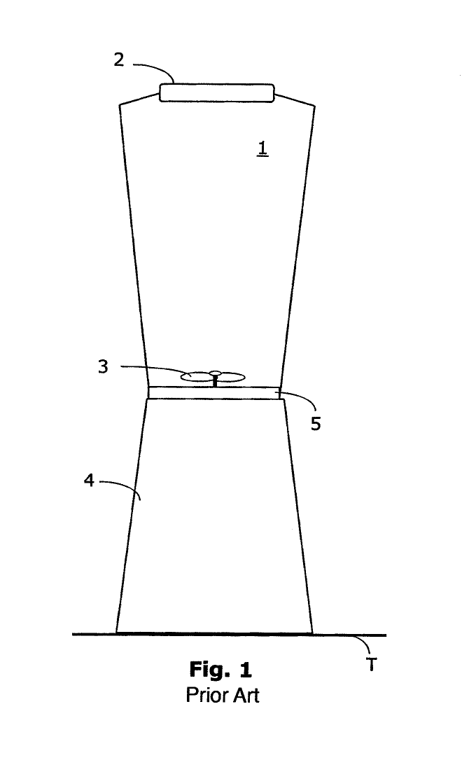

### DETAILED DESCRIPTION

In the following, the invention is described in terms of embodiments, which are particularly tailored to the field of edibles. The invention may be transferred without further ado to other terminology systems and/or areas of expertise. In other areas of expertise, the terms should be applied correspondingly.

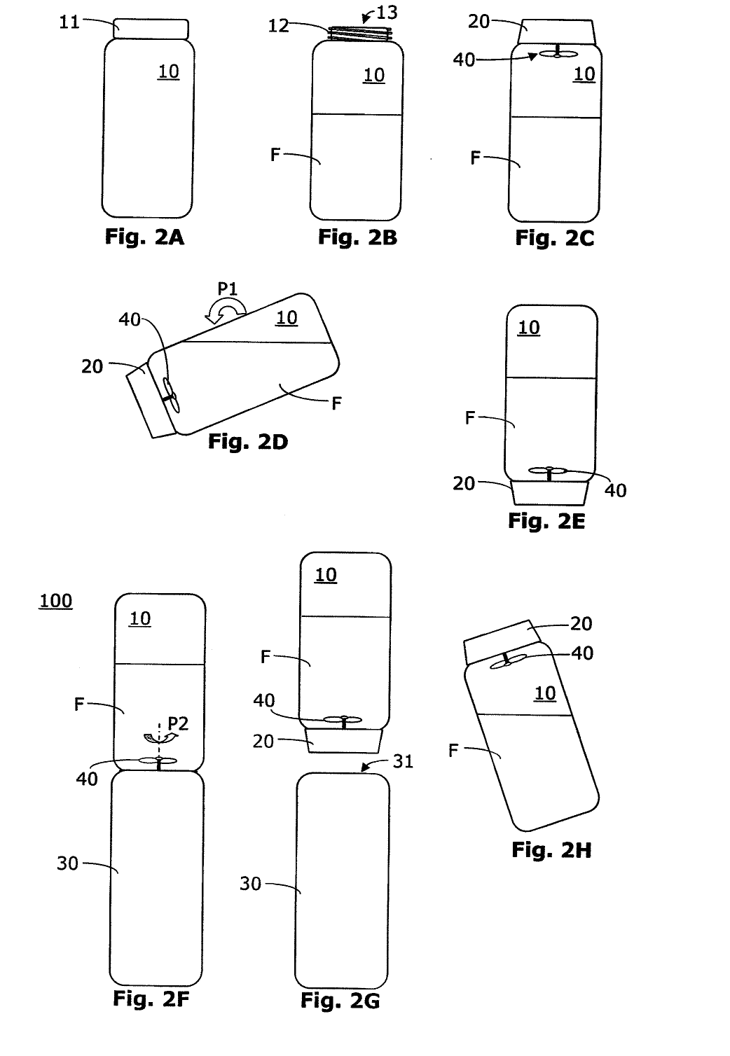

In the FIGS. 2A to 2H, a sequence of individual steps is shown. The basic elements of the invention shall be described on the basis of these individual steps.

FIG. 2A shows a container 10, here in the form of a drinking bottle, comprising a lid 11.

The term container 10 is used herein to paraphrase the following containers:

bottles,

cans,

tins,

mugs,

cups,

beakers, etc.

These containers 10 may be made for example from glass, plastic material, preferably polycarbonate (PC), polyethylene (PE), highly dense polyethylene (PE), or polypropylene (PP), aluminum or ceramic material.

The lid 11 is taken off, for example by screwing off. In FIG. 2B, the container 10 is shown accordingly without lid 11. The container 10 has an opening 13 in the upper area. In the area of this opening 13, an external thread, preferably a standardized external thread, is provided. However, other detachable connections between the container 10 and the lid 11 are conceivable, which allow for a tight closing of the container 10 by means of the lid 11.

The container may be filled with material F to be mixed through the opening 13. In FIG. 2B, a state is shown, in which the container 10 is filled up to approximately ⅔.

The term material F to be mixed is used herein among others to paraphrase

liquid and viscous material to be mixed with one or plural ingredients, or

mixtures or combinations of liquid and viscous material to be mixed with solid ingredients.

In the following, some examples of material to be mixed from the field of edibles are mentioned:

liquid (e.g. water) comprising flavor additives (e.g. sirup);

milk product comprising fruit (e.g. raspberry) or vegetable additives (e.g. cucumber);

mixed beverage from alcoholic and non-alcoholic portions; and

hot or cold beverages made of a liquid together with a soluble powder or granulate (e.g. instant coffee or soup powder).

The material to be mixed may also be taken from the field of non-food.

In a further step, see FIG. 2C, this opening 13 is then closed with a special lid 20 according to the invention. This lid 20 comprises a so-called stirring device 40, which is shown herein purely schematically. The stirring device 40 is integrated in the lid 20 so fixedly, that in total the container 10 is closed tightly. This issue is important, because otherwise when turning the container 10 filled with material F to be mixed, as indicated in FIG. D, material F to be mixed would leak.

In FIG. 2D, it is indicated that the container 10 is then turned upside down by a rotational movement. That is, the container 10 is turned such that it points downward the lid 20. This intermediate position is represented in FIG. 2E.

Then, the container 10 is connected, in this position, with the drive device 30. This is performed by a simple manual plugging and pressing of the container 10 against a connection area 31 of the drive device 30 which is arranged on the top side.

In FIG. 2F, a snap-shot is shown, in which the container 10 is connected with the drive device 30.

Upon connecting the container 10 with the drive device 30, the lid 20 is immerging wholly or partly into the connection area 31. At the same time, the stirring device 40 is connected with the drive device 30 as concerns the drive. This connection with respect to the drive makes sure a mechanical coupling between a drive, which is arranged at or in the drive device 30, and the stirring device 40.

If the drive is then operated or activated, a rotational movement of the drive around a vertical axis is generated. This rotational movement is transferred mechanically to a vertical axis R1 of the stirring device 40 and the stirring device 40 begins to rotate. In FIG. 2F, the rotational movement of the stirring device 40 is represented by the arrow P2.

The rotational movement P2 of the stirring device 40 causes an interaction of the stirring device 40 with the material F to be mixed. After a desired result has been achieved, the container 10 can be detached. Upon detaching, the connection as concerns the drive is disconnected. This moment is shown in FIG. 2G. Then, the container 10 can be reversed, as shown in FIG. 2H.

The material F to be mixed can then, after the removal of the special lid 20, be e.g. drunk or another lid (e.g. the original lid 11) can be put on.

By the steps mentioned, it is possible to prepare for example a milk shake with only a few manipulations as follows:
a. filling the container 10 through the opening 13 with a material F to be mixed composed of milk and raspberries (FIG. 2B),
b. closing the opening 13 with the lid 20 (FIG. 2C),
c. turning the container 10 together with the lid 20 (FIGS. 2D and 2E),
d. putting on the container 10 together with the lid 20 in the connection area 31 of the drive device 30 (FIG. 2F),
e. activating the drive device 30 so as to generate a rotational movement around a drive axis (vertical axis) (FIG. 2F),
f. force-fitly transmitting the rotational movement of the drive axis to an axis R1 of the stirring device 40 (FIG. 2F),
g. mixing the material F to be mixed by means of the rotation of the stirring device 40 (FIG. 2F),
h. separating the container 10, together with the lid 20, from the drive device 30 (FIG. 2G),
i. opening the lid 20 so as to get access to the material F to be mixed in the interior of the container 10.

This procedure takes only a few seconds and only a few dishes are contaminated, which would have to be cleaned afterwards.

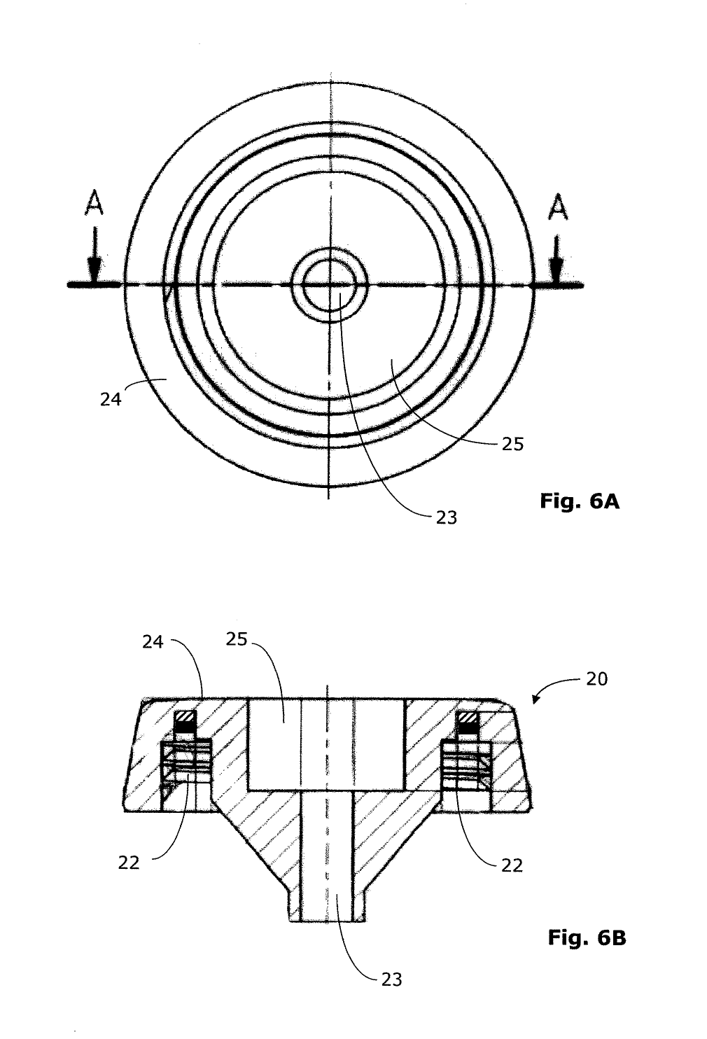

In a particularly preferred embodiment, the container 10 has an (exterior) thread 12 in the area of the opening 13, as indicated in FIG. 2B. The lid 20 then has a corresponding complementary (inner) thread 22, as shown in FIG. 6B.

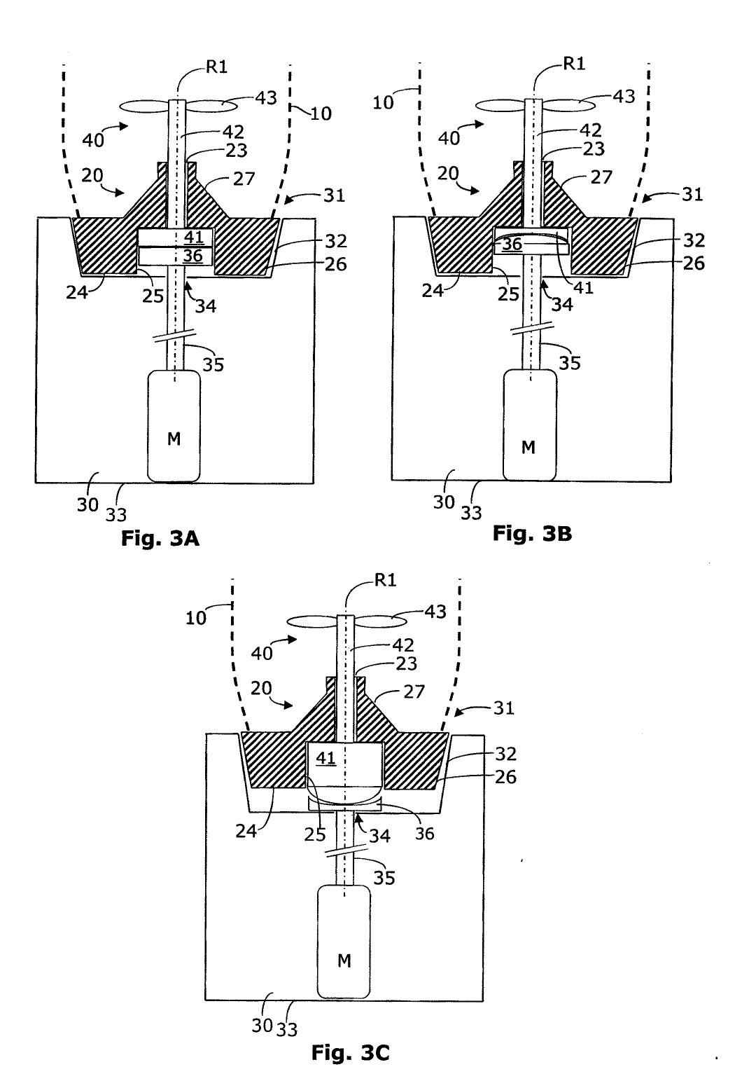

The lids 20 according to the invention are characterized in that they have a passage 23 for an axis, which enables driving the stirring device 40, which is located in the interior of the container 10 when the lid 20 is closed, from the exterior of the container 10. Details of different lids 20 of this kind are shown in the FIGS. 3A, 3B, 3C, 6A, 6B and 7. A rotationally symmetrical recess 25 is conceived on the top side of the lid 20. The passage 23 for the axis opens out into this recess 25. A plate-shaped catch 41 sits in the recess 25 in the lid 20 as mounted ready for use (i.e. as soon as the stirring device 40 is fixedly integrated in the production/assembling), which catch 41 comes in interaction with a counter piece 36 on the side of the drive.

The thread 12 of the container and the thread 22 of the lid 20 are formed such that by screwing on the lid 20, the opening 13 is closeable tightly.

The invention preferably makes use of a standardized thread 12, 22, so that commercial products from other suppliers can be applied for the purpose of the invention. In that way, for example bottles for sports and leisure time can be applied for mixing by a simple screwing on of the lid 20.

By means of the FIGS. 3A to 3C, three different embodiments of the connection as concerns the drive between the drive, here in the form of a motor M, and the stirring device 40 are shown. Schematized cross sectional views are concerned, each of which allows recognizing a lid 20, the stirring device 40 and parts of a drive device 30.

In FIG. 3A, an embodiment is shown, in which the stirring device 40 has a stirring device axis 42 and a stirring body 43. The stirring device axis 42 extends through a passage 23 for the axis. A rotationally symmetrical recess 25 is provided on the outer side of the lid 20. A plate-shaped catch 41, which is connected with the stirring device axis 42, sits in this recess 25.

The lid 20 is plugged, with its top side to the fore, in a recess 32 provided on the top side of the drive device 30. The recess 32 is a part of the connection area 31 of the drive device 30 arranged on the top side. The recess 32 has a conical side wall. The slope of the conical sidewall corresponds approximately to the slope of the conical outer wall 26 of the lid 20.

In the housing 33 of the drive device 30, an opening 34 for an axis is provided, through which a vertical axis 35, which is driven by the drive M, extends. At the end of the vertical axis 35, a counter piece 36 on the drive side is arranged, which comes in force-fitting interaction with the plate-shaped catch 41, when the container 10, together with the lid 20, is put on or plugged on.

In FIG. 3B, a similar embodiment is shown, the elements of which correspond substantially with the elements of FIG. 3A. However here, the plate-shaped catch 41 has a slightly concave surface. The counter piece 36 on the drive side has a complementary surface, which is shaped convexly. The plate-shaped catch 41 and the counter piece 36 engage with each other. Also here, a force-fit interaction is generated. An embodiment is particularly preferred, in which the concave surface of the catch 41 is formed rubber-elastically, similar as in a suction cup.

The embodiments of FIGS. 3A and 3B are characterized in that the container 10, together with the lid 20, can be deposited upside down, because the lid 20 has a straight surface 24. The plate-shaped catch 41 does not protrude beyond the surface 24.

In FIG. 3C, a similar embodiment is shown, the elements of which correspond substantially with the elements of the FIG. 3A and FIG. 3B. However here, the plate-shaped catch 41 has a convex surface. The counter piece 36 on the drive side has a complementary surface, which is shaped concavely. The plate-shaped catch 41 and the counter piece 36 engage with each other. Also here, a force-fit interaction is generated. An embodiment is particularly preferred, in which the concave surface of the counter piece 36 is formed rubber-elastically, similar as in a suction cup.

A lid 20 according to FIG. 3C is particularly suited for the case that a permanent leak tightness cannot be ensured to 100%. Since the lid 20 is not flat due to the convex (bulgy) catch 41, the container 10, together with the lid 20, cannot be deposited upside down.

Further optional details can be recognized in the FIGS. 3A to 3C. For example, the lid 20 has a conical extension 27, which extends into the interior of the container 10. By means of this extension 27, the stirring device 40 sits further in the interior of the container 10. The sloped side surface of the conical extension 27 facilitates the cleaning of the lid 20 and the drive device axis 42 can be sealed better with respect to the lid 20.

The stirring device 40 may comprise one or several stirring blades 43 (as indicated in FIGS. 3A to 3C), one or several stirring arms, one or several blade edges. A combination of these elements is also possible.

For particular fields of application, the lid 20 together with the stirring device may be designed as a disposable. Thus, paints or other multi component material to be mixed may be mixed and used for example in the fields of construction and hobby.

The drive device 30 may either be equipped with an own drive M, for example in the form of a motor, or the drive device 30 may be coupled to the drive of another device. In this respect, a connection with a kitchen equipment or a coffee machine comprising a crushing gear is particularly advantageous. In this case, the equipment or machine may have a connection area, analogously to the connection area 31. If required, the container 10 together with the lid 20 is set on at the connection area so as to activate the stirring device 30 by means of a motor of the equipment or machine.

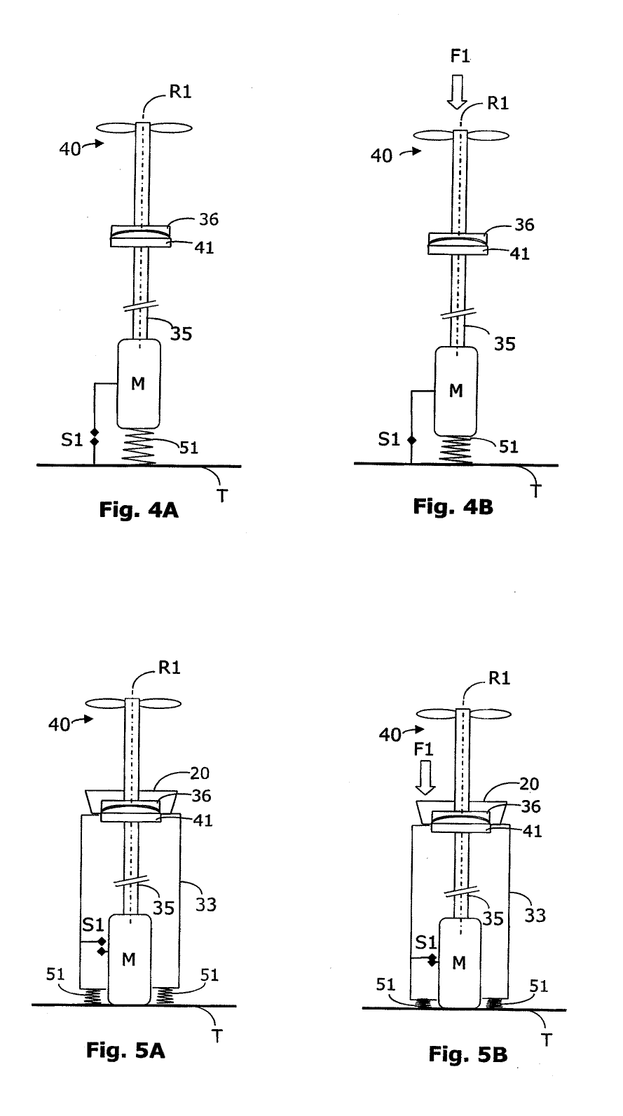

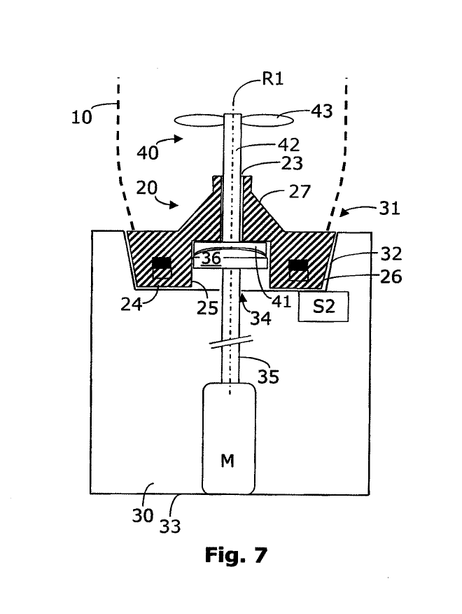

Special measures are proposed in order to reduce the risk of misuse or the risk of injury. Examples in this respect are shown in the FIGS. 4A, 4B, 5A, 5B and in FIG. 7, which may also be combined.

The drive of the apparatus 100 shall preferably not be actuated by a separate switch, but rather the motor M shall be switched on automatically upon putting on the container 10 together with the lid 20.

A first example in this respect is shown in the FIGS. 4A and 4B. For reasons of simplicity, only some basic elements are represented. Here, the motor M is seated on a spring 51 or a spring-elastic element. A switch S1 (also called pressure switch) is arranged such that the switch is closed only when a pressure F1 is applied and the current supply of the motor M is established. In FIG. 4B it is indicated that the motor M is pushed in the direction of the work surface T by the pressure F1, which acts on the axis 35 via the container 10 and the lid 20. Thereby, the spring 51 is compressed and the switch S1 is closed mechanically.

A second example is shown in the FIGS. 5A and 5B. For reasons of simplicity, only some basic elements are represented, too. Here, the motor M stands fixedly on a work surface T. However, the casing 33 is seated on a spring 51 or on spring-elastic elements. A switch S1 is arranged such that the switch is closed and the current supply to the motor M is established only when applying a pressure F1. In FIG. 5B it is indicated that by the pressure F1, which acts through the container 10 and the lid 20 on the casing 33, the casing 33 is pushed in the direction of the work surface T. Thereby, the springs 51 are compressed and the switch S1 is closed mechanically.

The two embodiments of the FIGS. 4A, 4B, 5A and 5B have proven to be safe and reliable. It is also conceivable that a user puts on the lid 20 together with the stirring device 40 on the connection area 31 and applies pressure F1. In this case, injuries may occur, because the drive M drives the stirring device 40 as soon as the switch S1 is closed. Thus, a force-fit connection between the elements 41 and 36 is preferably employed, which avoid that too strong a torque acts on the stirring device 40. When blocking the stirring device 40 with the fingers, the force-fit connection acts as a friction clutch, so as to avoid more serious injuries.

The embodiment, which is described in the following with respect to the FIGS. 6A, 6B and 7, offers still more safety. A first element of a magnet switch S2 is conceived in the lid 20. The second element of the magnet switch S2 is seated in the casing 33 close to the connection area 31 (see FIG. 7). In the cross section in FIG. 6B, it can be recognized that a metal ring 28 is seated for example on an elastic ring 29 in the lid 20. When fixedly screwing on the lid 20 on the container 10, the upper edge of the container 10 presses on the annular groove of the lid 20. By means of the pressure, which is exerted thereby, the metal ring 28 in the lid 20 is pressed upwards in the direction of the top side 24 of the lid and the elastic ring 29 is compressed. If now the container together with lid 20 fixedly screwed thereon is brought in the connection area 31, then the metal ring 28 is seated relatively close to the second element of the magnet switch S2. The immediate spatial proximity of the two elements leads to an interaction, which closes the magnet switch S2. Only when this magnet switch S2 is closed, the second switch S1 can supply current to the motor M by the application of pressure F1.

This embodiment offers several safety aspects. On one hand, the apparatus 100 can not be operated with a wrong lid. On the other hand, a tight closing is ensured, because only when screwing on the lid 20 sufficiently firmly, the metal ring 28 is pushed sufficiently close in the direction of the top side 24 of the lid. Especially however, the apparatus 100 can only be operated, when the lid 20 seals a container 10. The lid 20 alone can not activate the switch mechanism, because the distance between the metal ring 28 and the switch S2 is too large. The elastic seating by means of the elastic ring 29 puts the metal ring 28 back each time. It is an advantage of this embodiment, that no constructional modifications of the container 10 are required. The safety mechanism works with each container 10 which has a standard thread 12.

Preferably, the switch S1 and the switch S2 are connected in series, which means that the motor M is supplied with current only when both switches are closed. That is to say, only when the right lid 20 with built-in first element consisting of the metal ring 28 and elastic ring 29 is connected together with a suitable container 10 and only when this combination consisting of the lid 20 and the container 10 is correctly put on in the connection area and only if pressure F1 is applied, then the motor M starts to rotate.

A drive device 30, which comprises a so-called regulation switch S3 instead of a pure pressure switch S1, is particularly preferred. This regulation switch S3 is integrated in the drive device 30 such that by pushing on the container 10, a pressure force F1 acts on the drive device 30. This action operates the regulation switch S3 so as to connect the motor M with the current supply. By pushing more strongly, the pressure force on the drive device 30 is increased and the regulation switch S3 supplies the motor M with current such that the motor rotation speed increases. Optionally, the regulation switch S3 and the switch S2 can be connected in series, as described above.

Reference numerals

| | |
|---|---|
| special container | 1 |
| lid | 2 |
| stirring device | 3 |
| drive unit | 4 |
| cap | 5 |
| container | 10 |
| lid | 11 |
| outer thread | 12 |
| opening | 13 |
| special lid | 20 |
| complementary thread | 22 |
| passage of axis | 23 |
| top side of the lid | 24 |
| recess | 25 |
| conical outer wall | 26 |
| conical extension | 27 |
| metal ring | 28 |
| elastic ring | 29 |
| drive device | 30 |
| connection area | 31 |
| recess | 32 |
| casing | 33 |
| opening for the axis | 34 |
| vertical axis | 35 |
| counter piece | 36 |
| stirring device | 40 |
| plate-shaped catch | 41 |
| axis of stirring device | 42 |
| stirring body/stirring blades | 43 |
| spring seating | 51 |
| material to be mixed | F |
| force | F1 |
| motor | M |
| rotational movement | P1, P2 |
| vertical axis | R1 |
| switch | S1 |
| magnet switch | S2 |
| regulation switch | S3 |
| table/work surface | T |

1. Apparatus comprising:
a container comprising an opening,
a lid for closing the opening,
a stirring device which protrudes through the lid into the interior of the container,
a drive device comprising a drive for driving the stirring device, wherein the drive device has a connection section which is designed such that
the container together with the lid is connectable with the connection section and
that upon connecting, the stirring device is coupleable with the drive device as concerns the drive,
wherein
the stirring device and the lid form a fixed assembly, and
in that a first element is arranged in the lid and a second element in the connection section, which elements come into interaction upon putting on the container together with the lid and activate a current supply of the drive by means of the second element.

2. Apparatus according to claim 1, wherein the interaction concerns a magnetic interaction, wherein a metal element serves the first element and a magnetic switch or magnetic sensor serves as the second element.

3. Apparatus according to claim 2, wherein the metal element is supported spring-elastically in the interior of the lid, and an upper edge of the container displaces the metal element in the direction of the lid surface upon screwing the lid on the container.

4. Apparatus according to claim 1, wherein the container has a thread in the sector of the opening and in that the lid has a corresponding complementary thread, wherein the opening is closeable tightly by screwing on the lid.

5. Apparatus according to claim 1, wherein
the stirring device comprises an axis which extends through the lid and
the stirring device comprises a catch, which comes into force-fitting interaction with a counter piece of the drive device upon attaching the container.

6. Apparatus according to claim 1, wherein
the stirring device comprises an axis which extends through the lid and
the stirring device comprises a catch, which comes into form-fitting interaction with a counter piece of the drive device upon attaching the container.

7. Apparatus according to claim 1, wherein the stirring device comprises one or more of the following elements:
a stirring blade and/or
a stirring arm and/or
a blade.

8. Apparatus according to claim 1, wherein the connection section is designed such that upon connecting the container a peripheral area of the lid comes into interaction with an inner surface of the connection section.

9. Apparatus according to claim 8, wherein the drive device comprises a pressure switch which is integrated in the drive device such that by pressing on the container a pressure force acts on the drive device, which pressure force operates the pressure switch so as to activate a current supply of the drive.

10. Apparatus according to claim 8, wherein the drive device comprises a regulating switch which is integrated in the drive device such that
by pressing on the container a pressure force acts on the drive device, which force activates the regulating switch so as to activate a current supply of the drive,
by pressing on the container more strongly the pressure force on the drive device is increased and the regulating switch supplies the drive with power such that the motor rotation speed increases.

11. Apparatus according to claim 1, wherein
the container is made of food-compatible materials and
the apparatus comprises a drinking lid which is connectable with the container after the lid has been removed.

12. Apparatus according to claim 1, wherein the container is designed especially for receiving beverages, soups or other liquid to viscous edibles.

13. Container for use in an apparatus according to claim 1, wherein the container comprises:
a single opening,
a thread which is arranged in the sector of the opening,
a lid comprising a corresponding complementary thread, wherein the opening is closeable tightly by screwing on the lid, wherein a first element is arranged in the lid, which element is designed to come into interaction with a second element arranged in the connection section upon putting on the container together with the lid so as to activate a current supply of the drive by means of the second element,
a stirring device comprising a stirring device axis, a stirring body and a catch, wherein
the catch is accessible from the outside at a top side of the lid such that the catch can come into interaction with a corresponding counter piece upon connecting the container with a connection section of the drive device of the apparatus, and wherein
the stirring device is integrated fixedly in the lid such that after closing the opening with the lid the stirring device projects into the interior of the container.

14. Method for preparing a material to be mixed using an apparatus comprising
a container comprising an opening,
a lid for closing the opening,
a stirring device which is integrated fixedly in the lid such that after closing the opening with the lid the stirring device projects into the interior of the container,
a drive device comprising a drive for driving the stirring device,
wherein the following steps are performed:
a. filling the container with a material to be mixed through the opening,
b. closing the opening with a lid,
c. turning the container together with the lid,
d. connecting the container together with the lid with a connection section of the driving unit,
e. activating an interaction between a first element, which is integrated in the lid, and a second element, which is arranged in the connection section of the driving unit, so as to release a current supply of the driving unit,
f. activating the driving unit so as to generate a rotational movement of a drive axis,
g. transmitting the rotational movement to an axis of the driving unit axis of the driving unit,
h. mixing the material to be mixed by a rotation of the stirring device,
i. separating the container together with the sap from the driving unit,
j. opening the lid in order to obtain access to the material to be mixed in the interior of the container.

15. Method according to claim 14, wherein the material to be mixed comprises a plurality of ingredients and/or components.

16. Method according to claim 14, wherein the activating of the driving unit is effected by the exertion of manual pressure on the container, wherein this pressure acts on the driving unit and there releases a pressure switch or a regulation switch.

17. Method according to claim 14, wherein after the opening of the lid another lid, preferably a drinking lid, is fixed on the container.

18. Method according to claim 14, wherein it is used to prepare edibles.
